(19) United States
(12) Patent Application Publication
(10) Pub. No.: US 2018/0298747 A1
(43) Pub. Date: Oct. 18, 2018

(54) SYSTEM AND METHOD FOR MONITORING POSITIONS OF PIPE JOINTS IN PRODUCTION SYSTEM

(71) Applicant: General Electric Company, Schenectady, NY (US)

(72) Inventors: Gerardo Alonso Sanchez Soto, Rio de Janeiro (BR); Fabio Lattario Fonseca, Rio de Janeiro (BR); Marina Lundgren de Almeida Magalhaes, Rio de Janeiro (BR)

(21) Appl. No.: 15/490,686

(22) Filed: Apr. 18, 2017

(51) Int. Cl. E21B 47/09; E21B 33/06; G01S 15/06; G08B 21/18

(52) U.S. Cl. CPC E21B 47/091; G08B 21/182; G01S 15/06; E21B 33/061

(57) ABSTRACT

A system for monitoring a position of a pipe joint as the pipe joint moves through a production system along a longitudinal axis of a wellbore of the production system includes an ultrasonic sensor configured to detect the pipe joint. The system also includes a controller configured to receive a signal from the ultrasonic sensor. The controller includes a processor configured to determine a first position of the pipe joint along the longitudinal axis at a first time based on the signal. The processor is further configured to determine a displacement from the first position of the pipe joint, and to determine a second position of the pipe joint along the longitudinal axis at a second time based on the displacement. The controller also includes a memory configured to store the first position and the second position.

### BACKGROUND

The field of the disclosure relates generally to systems for oil and gas wells, and more particularly to a system for monitoring positions of pipe joints of a production system.

Many known oil and gas production systems include a pipe that extends through a wellbore. The pipe includes a plurality of pipe sections that are coupled together by pipe joints. At least some known oil and gas production systems include a blowout prevention (BOP) system that can seal the wellbore to inhibit release of materials through the wellbore when necessary. Sometimes, it is beneficial to determine when the pipe joints are adjacent the BOP system.

Therefore, it is desirable to provide a system for reliably determining positions of pipe joints in a production system.

### BRIEF DESCRIPTION

In one aspect, a system for monitoring a position of a pipe joint as the pipe joint moves through a production system along a longitudinal axis of a wellbore of the production system is provided. The system includes an ultrasonic sensor configured to detect the pipe joint. The system also includes a controller configured to receive a signal from the ultrasonic sensor. The controller includes a processor configured to determine a first position of the pipe joint along the longitudinal axis at a first time based on the signal. The processor is further configured to determine a displacement from the first position of the pipe joint, and to determine a second position of the pipe joint along the longitudinal axis at a second time based on the displacement. The controller also includes a memory configured to store the first position and the second position.

In another aspect, a production system is provided. The production system includes a pipe extending along a longitudinal axis of a wellbore. The pipe includes a plurality of sections coupled together by at least one joint. The production system also includes a detection system for monitoring a position of the at least one joint as the pipe moves through the wellbore. The detection system includes an ultrasonic sensor configured to detect the at least one joint. The detection system also includes a controller configured to receive a signal from the ultrasonic sensor and determine a first position of the at least one joint along the longitudinal axis at a first time based on the signal. The controller is further configured to determine a displacement from the first position of the at least one joint, and a second position of the at least one joint along the longitudinal axis at a second time based on the displacement.

In still another aspect, a method of monitoring a position of a pipe joint of a production system as the pipe joint moves along a longitudinal axis of a wellbore is provided. The method includes receiving, using a controller, a signal from a sensor that detects the pipe joint as the pipe joint moves along the longitudinal axis. The method also includes determining, using the controller, a first position of the pipe joint along the longitudinal axis based on the signal from the sensor. The method further includes receiving, using the controller, at least one operational parameter of the production system. The method also includes determining, using the controller, a second position of the pipe joint along the longitudinal axis based on the first position and the at least one operational parameter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary production system including a detection system;

FIG. 2 is a side view of a pipe joint of the production system shown in FIG. 1;

FIG. 3 is a series of schematic views of the pipe joints shown in FIG. 3 moving through the production system shown in FIG. 1;

FIG. 4 is a flow diagram of an exemplary method of monitoring positions of the pipe joints in the production system shown in FIG. 1; and

FIG. 5 is an illustration of user interface displays of the production system shown in FIG. 1 including geological representations of the wellbore.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

The methods and systems described herein provide reliable monitoring of pipe joints positions in a production system. For example, embodiments of the detection system include a sensor and a controller configured to receive signals from the sensor. Based on a signal from the sensor, the controller determines a first position of a pipe joint at a first time and a second position of the pipe joint at a second time. The controller determines the second position based on the first position and at least one operational parameter of the production system. In some embodiments, the controller compares the second position to a position of a ram of a blowout prevention (BOP) system and provides an alarm when the pipe joint is within a specified distance of the ram. As a result, the system facilitates reliable monitoring of the positions of the pipe joints and provides real-time data relating to the wellbore during operation.

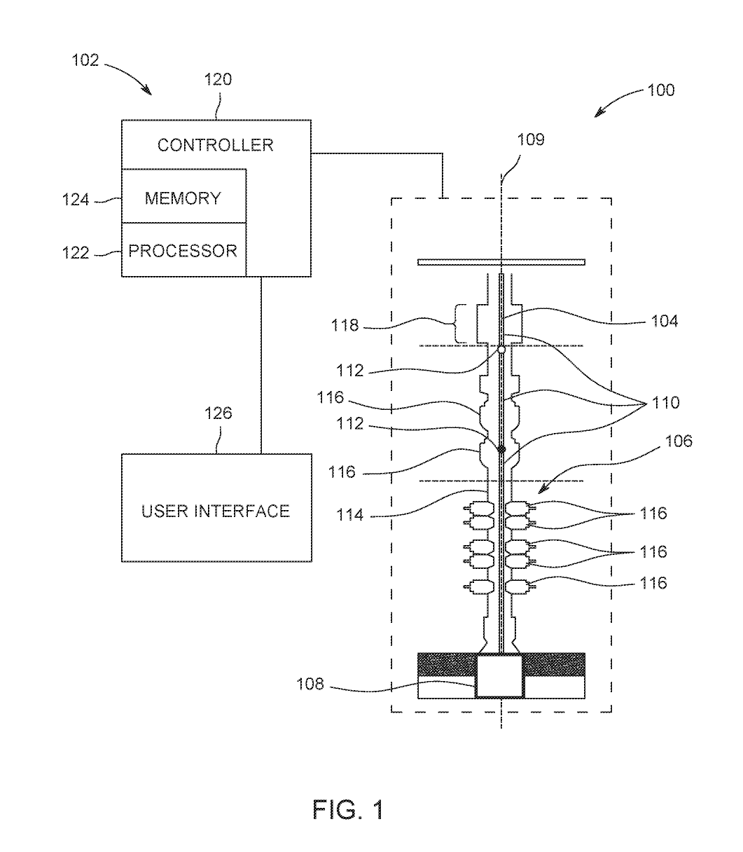

FIG. 1 is a schematic view of an exemplary production system 100 including a detection system 102. Production system 100 includes detection system 102, a pipe 104, and a BOP system 106. Pipe 104 extends through a wellbore 108 along a longitudinal axis 109 of wellbore 108 during operation of production system 100. For example, during a drilling phase, production system 100 is configured to transport fluid through pipe 104 to wellbore 108. In alternative embodiments, production system 100 has any configuration that enables production system 100 to operate as described herein.

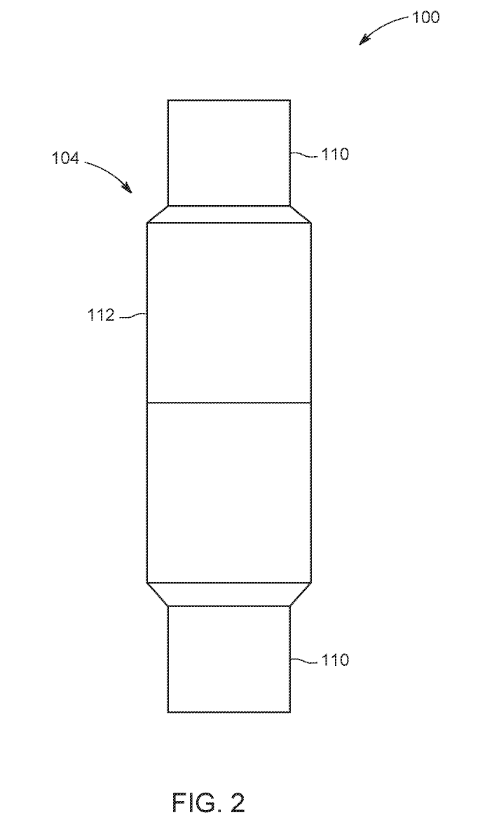

FIG. 2 is a side view of a pipe joint 112 of pipe 104. In the exemplary embodiment, pipe 104 includes a plurality of sections 110 coupled together by pipe joints 112. Pipe joints 112 have diameters that are larger than diameters of sections 110 to facilitate pipe joints 112 coupling sections 110 together. In some embodiments, pipe joints 112 include, for example and without limitation, welds, fasteners, seals, and any other coupling components. In alternative embodiments, production system 100 includes any pipe 104 that enables production system 100 to operate as described herein.

In reference to FIG. 1, in the exemplary embodiment, BOP system 106 includes a stack 114 and a plurality of blowout preventers 116 configured to seal wellbore 108. For example, blowout preventers 116 include, without limitation, annular preventers, a blind shear ram, a casing shear ram, a pipe ram, and/or any other suitable blowout preventer. As pipe 104 moves through BOP system 106, detection system 102 determines positions of pipe joints 112 and relates the positions to BOP system 106 to allow BOP system 106 to avoid sealing wellbore 108 at pipe joints 112. In alternative embodiments, production system 100 includes any BOP system 106 that enables production system 100 to operate as described herein.

In the exemplary embodiment, detection system 102 includes a sensor 118 and a controller 120. Sensor 118 is coupled to BOP system 106 and is configured to detect pipe joints 112. Sensor 118 sends signals relating to pipe joints 112 to controller 120. In the exemplary embodiment, sensor 118 detects a first end and a second end of pipe joint 112. Accordingly, sensor 118 allows determination of a size of pipe joint 112 based on a known and/or measured velocity of pipe 104. In some embodiments, sensor 118 is an ultrasonic sensor. In alternative embodiments, detection system 102 includes any sensor 118 that enables detection system 102 to operate as described herein.

Also, in the exemplary embodiment, controller 120 is communicatively coupled to sensor 118 and configured to receive signals from sensor 118. Controller 120 includes a processor 122 and a memory 124. Processor 122 is configured to determine a first position of pipe joint 112 along longitudinal axis 109 at a first time based on a signal from sensor 118. Processor 122 is further configured to determine a second position of pipe joint 112 along longitudinal axis 109 at a second time based on the first position and at least one operational parameter. Memory 124 is coupled to processor 122 and is configured to store information such as positions of pipe joint 112 and operational parameters. In some embodiments, processor 122 is configured to retrieve and store information on memory 124. In further embodiments, controller 120 is configured to communicate with components such as sensor 118 using communication protocols including open platform communications (OPC), OPC unified architecture (OPC UA), websocket, and/or any other suitable communication protocol. In alternative embodiments, detection system 102 includes any controller 120 that enables detection system 102 to operate as described herein.

Controller determines positions of pipe joints 112 based on any operational parameter that enables detection system 102 to operate as described herein. For example, in some embodiments, operational parameters include, without limitation, a time that sensor 108 detects pipe joint 112 (i.e., a detection time), time elapsed from the detection time, an operational setting of production system 100, a velocity of a traveling block, a rate of penetration, a distance between stack components, a design characteristic of production system 100, and a size of pipe joint 112. As used herein, the term “traveling block” refers to a freely moving assembly configured to receive a drill line. The term “rate of penetration” refers to the rate at which a drilling component moves through material. In alternative embodiments, controller 120 utilizes any operational parameter that enables detection system 102 to operate as described herein.

In some embodiments, operational parameters are received by controller 120 from sensors and/or other components of production system 100. In further embodiments, operational parameters are provided by a user. In some embodiments, controller 120 determines the operational parameters from sensor readings and/or user inputs. In alternative embodiments, controller 120 receives an operational parameter from any component that enables detection system 102 to operate as described herein.

In addition, in the exemplary embodiment, production system 100 includes a user interface 126. User interface 126 is configured to provide data to a user and/or receive user inputs. For example, in some embodiments, user interface 126 includes a display which provides data in a readable format for the user. In further embodiments, user interface 126 includes a keyboard and/or other input device. In alternative embodiments, production system 100 includes any user interface 126 that enables production system 100 to operate as described herein. In some embodiments, user interface 126 is omitted and production system 100 is at least partially automated.

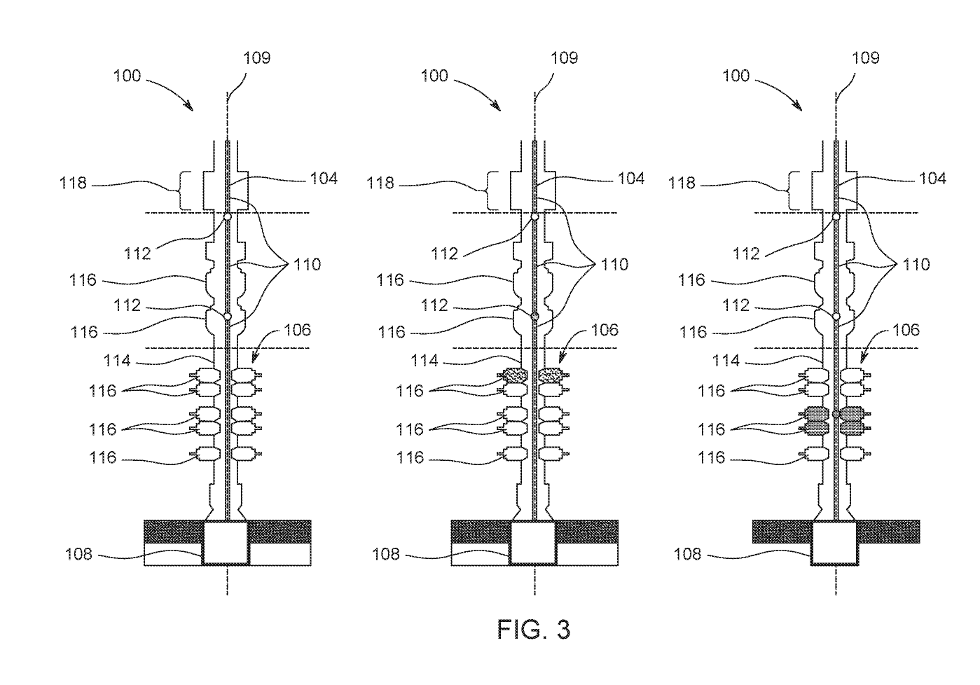

FIG. 3 is a series of schematic views of pipe joints 112 moving through production system 100. In some embodiments, user interface 126 (shown in FIG. 1) provides the schematic views of pipe joints 112 to a user in a readable format such as on a display screen. In reference to the orientation shown in FIG. 3, pipe joints 112 move vertically through wellbore 108 along longitudinal axis 109 of wellbore 108. Sensor 118 is coupled to wellbore 108 at a known distance from blowout preventers 116. In the exemplary embodiment, pipe joints 112 move downward, such as in a forward drilling process, and sensor 118 detects pipe joints 112 above blowout preventers 116. In alternative embodiments, sensor 118 is positioned in any manner that enables production system 100 to operate as described herein. For example, in some embodiments, pipe joints 112 move upwards and sensor 118 is positioned below blowout preventers 116. In further embodiments, production system 100 includes a plurality of sensors 118 in different positions.

In the exemplary embodiment, detection system 102 facilitates real-time monitoring of the position of pipe joints 112 to avoid blowout preventers 116 actuating when pipe joints 112 are within blowout preventers 116. For example, detection system 102 determines when pipe joints 112 are within a predetermined distance of blowout preventers 116. In some embodiments, user interface 126 (shown in FIG. 1) provides an alarm, such as a graphical indicator, to a user when pipe joints 112 are within the predetermined distance of blowout preventers 116.

In reference to FIG. 1, in the exemplary embodiment, controller 120 determines a distance between pipe joint 112 and blowout preventers 116. When the distance is less than a predetermined distance, controller 120 triggers an alarm. For example, in some embodiments, user interface 126 provides a visual indicator to the user that pipe joint 112 is within a predetermined distance of blowout preventer 116. In some embodiments, controller 120 determines distances to each blowout preventer 116. In further embodiments, user interface 126 provides a separate visual indicator for each blowout preventer 116.

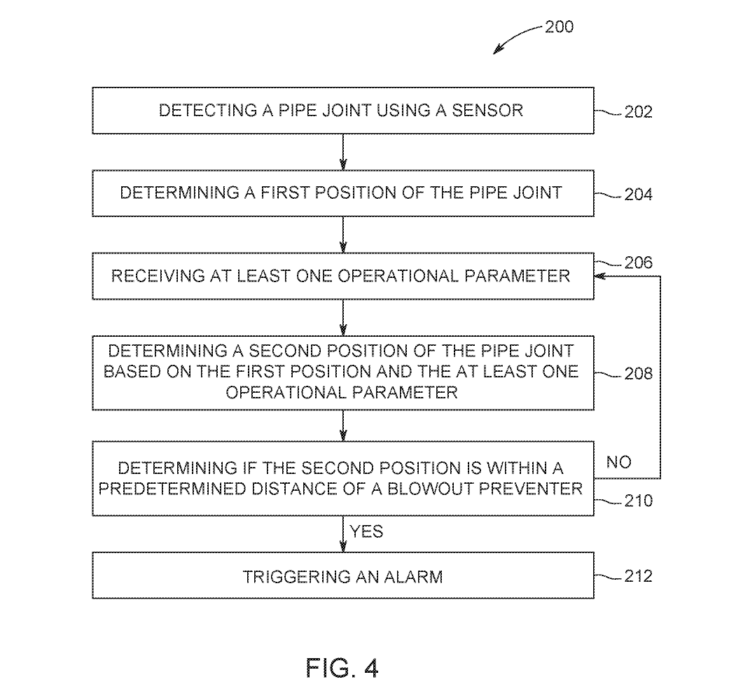

FIG. 4 is a flow diagram of an exemplary method 200 of monitoring positions of pipe joints 112 of production system 100. In reference to FIGS. 1 and 4, method 200 generally includes detecting 202 pipe joint 112 using sensor 118, determining 204 a first position of pipe joint 112, receiving 206 at least one operational parameter, determining 208 a second position of pipe joint 112 based on the first position and the at least one operational parameter, determining 210 if the second position is within a predetermined distance of blowout preventer 116, and triggering 212 an alarm if the second position is within a predetermined distance of blowout preventer 116.

In the exemplary embodiment, detecting 202 includes detecting a first end of pipe joint 112 and a second end of pipe joint 112. In some embodiments, the distance between the ends of pipe joint 112 is determined based on the detected ends and a velocity of pipe joint 112. Sensor 118 sends a signal to controller 120 when sensor 118 detects pipe joint 112. In some embodiments, controller 120 determines the initial time that sensor 118 detected pipe joint 112. In alternative embodiments, pipe joint 112 is detected in any manner that enables production system 100 to operate as described herein. For example, in some embodiments, pipe joint 112 is detected 202 using algorithms involving denoising techniques, statistical approaches, machine learning, and/or artificial intelligence.

Also, in the exemplary embodiment, controller 120 determines 208 the second position of pipe joint 112 based on at least one of the following parameters: a detection time, an elapsed time, an operational setting, a velocity of a traveling block, a rate of penetration, a stack configuration, a distance between stack components, a design characteristic of production system 100, and a size of pipe joint 112. For example, in some embodiments, controller 120 estimates a displacement of pipe joint 112 based on the time elapsed from when sensor 118 detected pipe joint 112 and the velocity of pipe joint 112. Specifically, controller 120 multiplies the elapsed time by the velocity to determine the displacement from the first position of pipe joint 112. In some embodiments, the velocity of pipe joint 112 is determined based on the velocity of a traveling block, a rate of penetration, and/or any other suitable parameter. In addition, controller 120 relates the position of pipe joint 112 to positions of other components of production system 100, such as blowout preventers 116 and other pipe joints 112. In some embodiments, controller 120 relates the position of pipe joint 112 to known dimensions of production system 100. In alternative embodiments, the position of pipe joint 112 is determined in any manner that enables production system 100 to operate as described herein.

In some embodiments, the predetermined distance is input by a user. In further embodiments, controller 120 determines the distance in any manner that enables production system 100 to operate as described herein. In the exemplary embodiment, controller 120 compares the predetermined distance to the distance between the second position and blowout preventer 116. If the second position is not within the predetermined distance, method 200 returns to detecting 202 pipe joint 112. If the second position is within the predetermined distance, controller 120 triggers 212 an alarm.

In addition, in some embodiments, method 200 includes detecting 202 a plurality of pipe joints 112 and monitoring the positions of pipe joints 112 in real-time. Accordingly, method 200 allows for real-time modeling of production system 100. For example, in some embodiments, controller 120 determines the total number of pipe joints in production system 100 based on information from sensor 118.

Also, in some embodiments, the spacing between pipe joints 112 is used to determine the positions of pipe joints 112. For example, in some embodiments, a first position of a first pipe joint 112 is determined and positions of subsequent pipe joints 112 are determined based on the first position of the first pipe joint 112 and the spacing between pipe joints 112. In further embodiments, a second position of the second pipe joints 112 is determined based on any of the following: the first position of the first pipe joint 112, a first position of the second pipe joint 112, an operational parameter, and spacing between pipe joints 112.

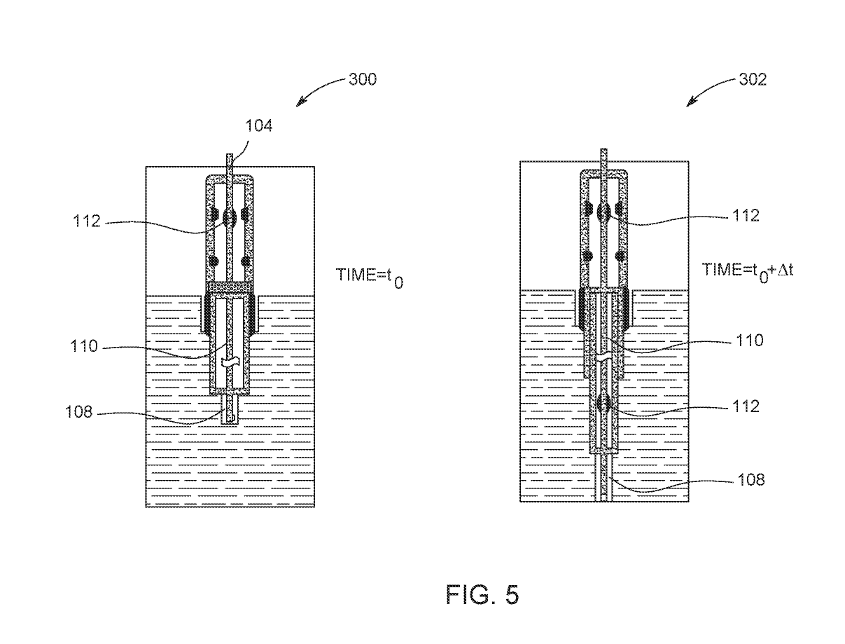

FIG. 5 is an illustration of first and second user interface displays 300 and 302 of production system 100 including geological representations of wellbore 108. For example, the geological representations of wellbore 108 include geological characteristics and features of wellbore 108 and the land around wellbore 108, such as types of materials, thickness of layers of materials, dimensions of wellbore 108, and any other suitable characteristic and feature. The term “geological characteristic” refers to a characteristic relating to land. In some embodiments, the geological representations are meant to simulate aspects of wellbore 108. In further embodiments, the geological representations are schematic and include symbols to represent features of wellbore 108. In alternative embodiments, first and second user interface displays 300 and 302 include any geological representation that enables first and second user interface displays 300 and 302 to operate as described herein.

In the exemplary embodiment, display 300 depicts production system 100 performing a forward drilling process through wellbore 108, i.e., drilling ahead. In alternative embodiments, displays depict processes including, without limitation, tripping out, disconnection, making a connection, and pulling out of the hole.

Also, in the exemplary embodiment, displays 300 and 302 depict pipe joints 112 at different positions during operation of production system 100. For example, as shown by display 300, sensor 118 detects pipe joint 112 at a first position at a first time. At a second time, as shown by display 300, pipe joint 112 is at a second position which is lower than the first position in reference to the orientation shown in FIG. 5. Accordingly, the positions of pipe joints 112 indicate pipe 104 is moving downward into wellbore 108. The position of pipe joints 112 are recorded throughout operation of production system 100. In some embodiments, the positions are included in a log that is replayable at different speeds and used for analyzing the operation of production system 100.

In some embodiments, a geological model of wellbore 108 is generated using information relating to the position of pipe joints 112. For example, in some embodiments, controller 120 determines characteristics such as number of pipe joints 112, length of pipe sections 110, and depth of pipe 104. In some embodiments, a total measure depth of wellbore 108 is calculated and compared to a plan. In further embodiments, drilling progress reports are generated and used to compare actual progress to a plan. In alternative embodiments, controller 120 determines any characteristic that enables production system 100 to operate as described herein.

The above-described methods and systems provide reliable monitoring of pipe joints positions in a production system. For example, embodiments of the detection system include a sensor and a controller configured to receive signals from the sensor. Based on a signal from the sensor, the controller determines a first position of a pipe joint at a first time and a second position of the pipe joint at a second time. The controller determines the second position based on the first position and at least one operational parameter of the production system. In some embodiments, the controller compares the second position to a position of a ram of a blowout prevention (BOP) system and provides an alarm when the pipe joint is within a specified distance of the ram. As a result, the system facilitates reliable monitoring of the positions of the pipe joints and provides real-time data relating to the wellbore during operation.

An exemplary technical effect of the methods, systems, and apparatus described herein includes at least one of: (a) providing a position of a pipe joint relative to BOP systems; (b) increasing reliability of BOP systems; (c) providing data relating to real-time geometry of a wellbore during operation; (d) providing a detection system that is compatible with different production systems; (e) providing a detection system for retrofitting to production systems; and (f) increasing safety and efficiency of production systems.

Some embodiments involve the use of one or more electronic or computing devices. Such devices typically include a processor or controller, such as a general purpose central processing unit (CPU), a graphics processing unit (GPU), a microcontroller, a field programmable gate array (FPGA), a reduced instruction set computer (RISC) processor, an application specific integrated circuit (ASIC), a programmable logic circuit (PLC), and/or any other circuit or processor capable of executing the functions described herein. In some embodiments, the methods described herein are encoded as executable instructions embodied in a computer readable medium, including, without limitation, a storage device, and/or a memory device. Such instructions, when executed by a processor, cause the processor to perform at least a portion of the methods described herein. The above examples are exemplary only, and thus are not intended to limit in any way the definition and/or meaning of the term processor.

Exemplary embodiments of BOP methods, systems, and apparatus are not limited to the specific embodiments described herein, but rather, components of systems and/or steps of the methods may be utilized independently and separately from other components and/or steps described herein. For example, the methods may also be used in combination with other systems requiring shear rams, and are not limited to practice with only the systems and methods as described herein. Rather, the exemplary embodiment can be implemented and utilized in connection with many other applications, equipment, and systems that may benefit from increased cutting efficiency.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for monitoring a position of a pipe joint as the pipe joint moves through a production system along a longitudinal axis of a wellbore of the production system, said system comprising:
an ultrasonic sensor configured to detect the pipe joint; and
a controller configured to receive a signal from said ultrasonic sensor, said controller comprising:
a processor configured to determine a first position of the pipe joint along the longitudinal axis at a first time based on the signal, wherein said processor is further configured to determine a displacement from the first position of the pipe joint, and to determine a second position of the pipe joint along the longitudinal axis at a second time based on the displacement; and
a memory coupled to said processor, wherein said memory is configured to store the first position and the second position of the pipe joint.

2. The system in accordance with claim 1, wherein said processor is configured to determine the displacement of the pipe joint based on the first position and at least one of a detection time, an elapsed time, an operational setting, a velocity of a traveling block, a rate of penetration, a distance between stack components, a design characteristic, and a size of the pipe joint.

3. The system in accordance with claim 1, wherein said controller is further configured to determine a distance of the pipe joint from a blowout preventer and generate an alarm when the distance is less than a predetermined distance.

4. The system in accordance with claim 1 further comprising a user interface configured to display data relating to the pipe joint, wherein said user interface is configured to alert a user when the pipe joint is within a predetermined distance of a blowout preventer.

5. A production system comprising:
a pipe extending along a longitudinal axis of a wellbore, said pipe comprising a plurality of sections coupled together by at least one joint;
a blowout prevention system extending along the longitudinal axis; and
a detection system for monitoring a position of said at least one pipe joint as said pipe moves along the longitudinal axis, said detection system comprising:
an ultrasonic sensor coupled to said blowout prevention system and configured to detect said at least one joint; and
a controller configured to receive a signal from said ultrasonic sensor and determine a first position of said at least one joint along the longitudinal axis at a first time based on the signal, wherein said controller is further configured to determine a displacement from the first position of said at least one joint, and to determine a second position of said at least one joint along the longitudinal axis at a second time based on the displacement.

6. The production system in accordance with claim 5, wherein said controller is configured to determine the second position of the pipe joint along the longitudinal axis at the second time based on the first position and at least one of a detection time, an elapsed time, an operational setting, a velocity of a traveling block, a rate of penetration, a stack configuration, a distance between stack components, a design characteristic, and a size of the pipe joint.

7. The production system in accordance with claim 5 further comprising a blowout preventer configured to seal the wellbore, said pipe configured to extend through said blowout preventer, wherein said controller is further configured to determine a distance of said at least one joint from said blowout preventer and generate an alarm when the distance is less than a predetermined distance.

8. The production system in accordance with claim 5 further comprising a user interface configured to display data relating to the first position and the second position, wherein said user interface is configured to alert a user when said at least one joint is within a predetermined distance of a blowout preventer.

9. The production system in accordance with claim 5, wherein said controller is configured to determine the second position based on the first position, a detection time, an elapsed time, and a rate of movement of said at least one joint.

10. The production system in accordance with claim 5, wherein said at least one joint comprises a first joint and a second joint.

11. A method of monitoring a position of a pipe joint of a production system as the pipe joint moves through the production system along a longitudinal axis of a wellbore, said method comprising:
receiving, using a controller, a signal from a sensor that detects the pipe joint as the pipe joint moves along the longitudinal axis;
determining, using the controller, a first position of the pipe joint along the longitudinal axis based on the signal from the sensor;
receiving, using the controller, at least one operational parameter of the production system; and
determining, using the controller, a second position of the pipe joint along the longitudinal axis based on the first position and the at least one operational parameter.

12. The method in accordance with claim 11, wherein determining a second position of the pipe joint along the longitudinal axis based on the first position and the at least one operational parameter comprises determining a second position of the pipe joint along the longitudinal axis based on the first position and at least one of a detection time, an elapsed time, an operational setting, a velocity of a traveling block, a rate of penetration, a stack configuration, a distance between stack components, a design characteristic, and a size of the pipe joint.

13. The method in accordance with claim 11 further comprising determining a distance of the pipe joint from a blowout preventer.

14. The method in accordance with claim 13 further comprising generating an alarm when the distance is less than a predetermined distance.

15. The method in accordance with claim 13 further comprising displaying data relating to the first position and the second position on a user interface.

16. The method in accordance with claim 11, wherein the pipe joint is a first pipe joint, said method further comprising determining a first position of a second pipe joint based on the first position of the first pipe joint.

17. The method in accordance with claim 16 further comprising determining a second position of the second pipe joint based on the first position of the first pipe joint and the at least one operational parameter.

18. The method in accordance with claim 11, wherein the production system includes a plurality of pipe joints, and wherein the controller is configured to receive a plurality of signals from the sensor, said method further comprising determining, using the controller, a number of the pipe joints of the production system based on the plurality of signals.

19. The method in accordance with claim 18 further comprising generating a geological representation of the production system based on the plurality of signals.

20. The method in accordance with 11 further comprising determining an elapsed time between the first time and the second time, and estimating the second position of the pipe joint along the longitudinal axis based on the first position, the elapsed time, and a velocity of the pipe joint.
